(19) United States
(12) Patent Application Publication
(10) Pub. No.: US 2006/0209484 A1
(43) Pub. Date: Sep. 21, 2006

(54) Illuminated pushbutton switch assembly

(76) Inventors: Robb R. Roell, Allenton, WI (US); John Steven Sedgwick, Blanchester, OH (US)

Correspondence Address: MICHAEL BEST & FRIEDRICH, LLP, 100 E WISCONSIN AVENUE, MILWAUKEE, WI, 53202, US

(21) Appl. No.: 11/081,817

(22) Filed: Mar. 16, 2005

(51) Int. Cl. H02H 9/06

(52) U.S. Cl. 361/118

(57) ABSTRACT

A pushbutton switch assembly to which an AC supply current or a DC supply current can be provided. The pushbutton switch assembly can include a pushbutton and a light-emitting diode that illuminates the pushbutton. The pushbutton switch assembly can also include a rectifier circuit that converts the AC supply current to a DC drive current and provides the DC drive current to the light-emitting diode. In some embodiments, the rectifier circuit can provide a DC drive current to the light-emitting diode regardless of a polarity of the DC supply current.

### BACKGROUND OF THE INVENTION

Illuminated pushbutton switch assemblies can be used in door chimes and intercoms. A conventional pushbutton switch assembly includes a pushbutton that can be pressed in order to generate a signal that can alert residents to the presence of a visitor. Pushbuttons can be illuminated to assist a visitor with locating the pushbutton in a dark entryway. Conventionally, an incandescent bulb is used to illuminate the pushbutton, and is typically powered by a nominal low-voltage power supply (e.g., a low-voltage transformer having an output of less than 30 Volts AC).

### SUMMARY OF THE INVENTION

The pushbutton switch assembly according to some embodiments of the invention can include a pushbutton and a light-emitting diode (LED) that illuminates the pushbutton. The pushbutton switch assembly can also include a rectifier circuit connected to the light-emitting diode. The rectifier circuit can convert an AC supply current to a DC drive current and can provide the DC drive current to the light-emitting diode. In other embodiments, the rectifier circuit can provide a DC drive current to the light-emitting diode from the DC supply current regardless of a polarity of the DC supply current.

### BRIEF DESCRIPTION OF THE DRAWINGS

FIG. 1 is a perspective view of a pushbutton switch assembly according to one embodiment of the invention.

FIG. 2 is an exploded front perspective view of the pushbutton switch assembly of FIG. 1.

FIG. 3 is an exploded rear perspective view of the pushbutton switch assembly of FIG. 1.

FIG. 4 is a schematic illustration of a door chime signaling device including the pushbutton switch assembly of FIG. 1.

FIG. 5 is a schematic illustration of an intercom signaling device including the pushbutton switch assembly of FIG. 1.

FIG. 6 is a circuit diagram for one embodiment of a rectifier circuit for use in the pushbutton switch assembly of FIG. 1.

FIG. 7 is a circuit diagram for another embodiment of a rectifier circuit for use in the pushbutton switch assembly of FIG. 1.

FIG. 8 is a circuit diagram for still another embodiment of a rectifier circuit for use in the pushbutton switch assembly of FIG. 1.

FIG. 9 is a circuit diagram for yet another embodiment of a rectifier circuit for use in the pushbutton switch assembly of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

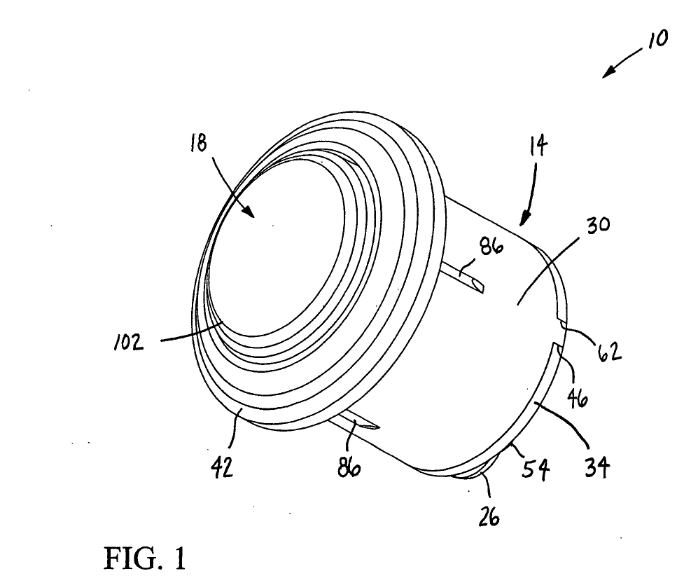

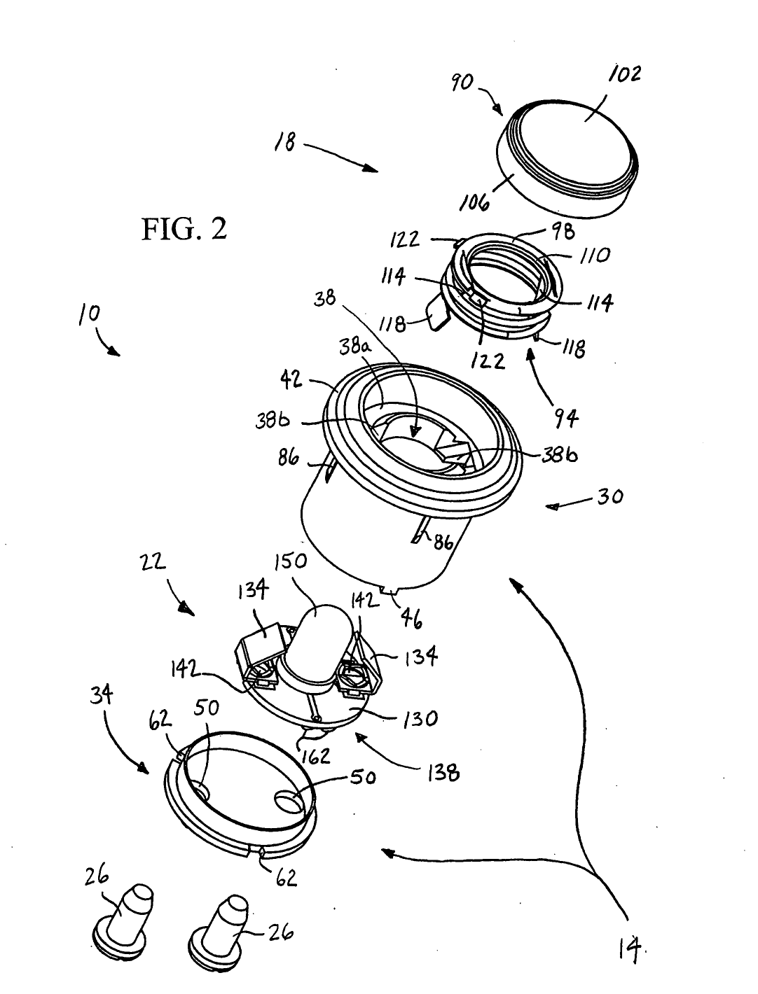

FIGS. 1-3 illustrate an illuminated pushbutton switch assembly 10 according to one embodiment of the invention. The assembly 10 can include a housing 14, a button assembly 18, a circuit assembly 22, and electrical connectors 26. The housing 14 can include a base 30 and a cover 34. The housing 14 can take any form and shape desired, such a housing defined at least in part by a number of walls and a frame, or a housing having a round, rectangular, or irregular cross-sectional shape. The base 30 can include a cavity 38 sized to receive at least part of the button assembly 18 and the circuit assembly 22. In some embodiments, the base 30 can include a bezel, such as a bezel 42 located at an end of the base 30. As shown in FIG. 2, the bezel 42 can taper to a reduced thickness with greater radial distance from the cavity 38. This taper can be defined by an angled or curved bezel face. Alternatively, the face of the bezel 42 can be stepped or substantially flat.

The cover 34 can enclose a portion of the base 30. For example, a second end of the base 30 can be covered by the cover 34. The cover 34 can be permanently or releasably secured to the base 30 in any suitable manner, or can be integral with the base 30. The cover 34 can be secured to the base 30 by screws, bolts, rivets, or other suitable fasteners, by adhesive or cohesive bonding material, etc. Alternatively, the cover 34 can be secured to the housing by snap-fit or other inter-engaging elements or features, such as detents, holes, recesses, dimples, grooves, or other apertures in the cover 34 shaped to receive bumps, fingers, ribs, ramps, pins, bosses, or other protuberances on the base 30 (and/or vice versa).

In one embodiment, the cover 34 can be removably attached to the base 30 by a snap-fit connection. As shown in FIGS. 1, 2 and 3, tabs 46 on the base 30 can mate with recesses 62 on the cover 34 in order to secure the cover 34 to the base 30. The cover 34 and the base 30 can be constructed of plastic and/or metal that is sufficiently resilient but deformable to permit engagement and disengagement by deformation of the cover 34 and/or the base 30.

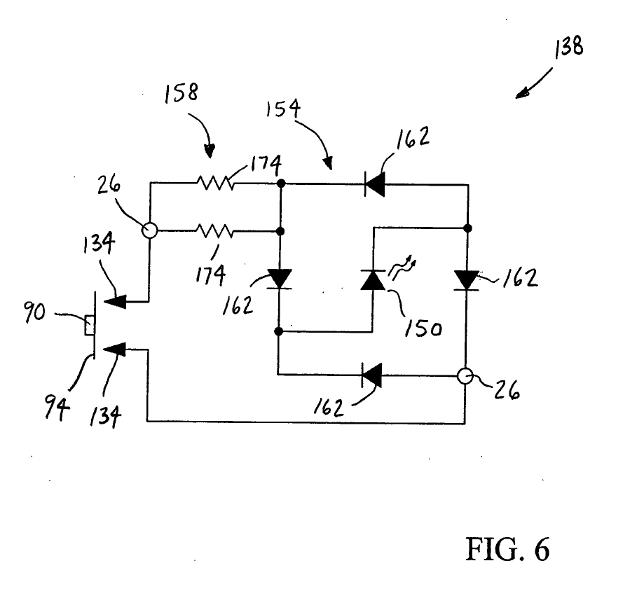

In some embodiments, one or more electrical connectors 26 for providing power to the assembly 10 can be coupled to the cover 34. Alternatively, the electrical connectors 26 can be located in any other position on the assembly 10, such as on a side of the base 30, on a surface of the circuit assembly 22, etc. The electrical connectors 26 can be threaded fasteners that can be tightened to connect power wiring to the assembly 10. In other embodiments, any other type of electrical connector can be used to enable an installer to connect power wiring to the assembly 10. For example, the electrical connectors 26 can include male-female electrical connectors on power wiring and on the cover 34 or other part of the assembly 10. More particularly, female electrical connectors on power wiring can be inserted over electrical tabs or pins on the cover 34, and vice versa. Alternatively, one or more electrical sockets on the cover 34 can be connected to one or more male plugs on the power wiring, and vice versa. As other examples, wiring connections can be made by using bolts, rivets, or other suitable fasteners as electrical connectors. The electrical connectors 26 are also shown schematically in FIGS. 6-9.

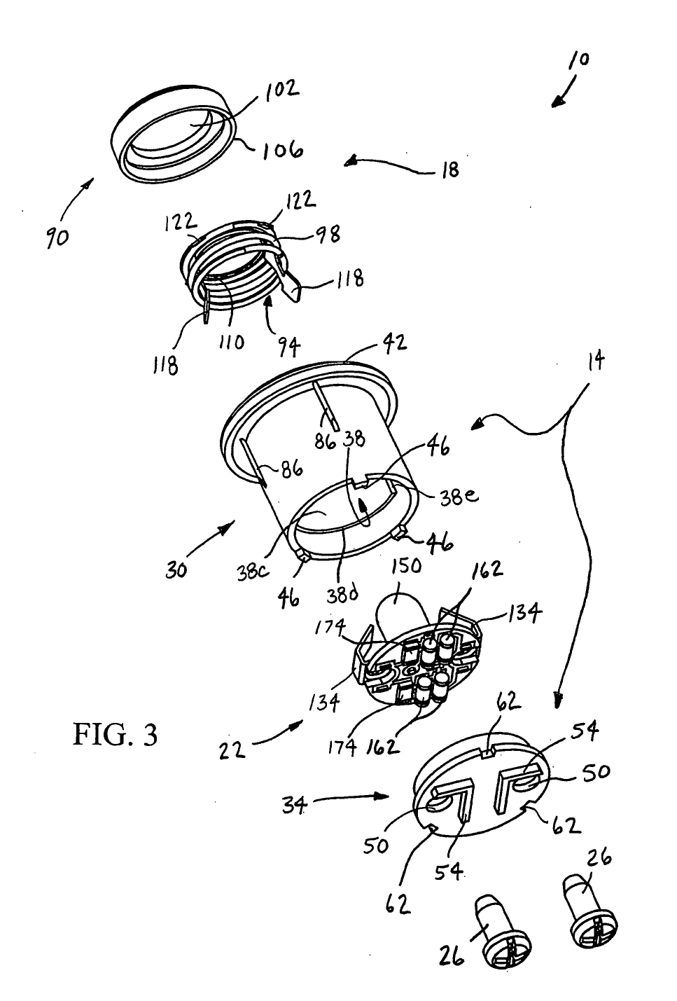

In some embodiments, as shown in FIGS. 2 and 3, the cover 34 can include apertures 50 through which the electrical connectors 26 can be positioned. In some embodiments, the wiring connections to the assembly 10 can be shielded from one another by recessing the electrical connectors 26 in the cover 34. For example, as shown in FIG. 3, one or more walls, such as L-shaped raised surfaces 54 adjacent each of the apertures 50, can shield the wiring connections and/or the electrical connectors 26 from one another.

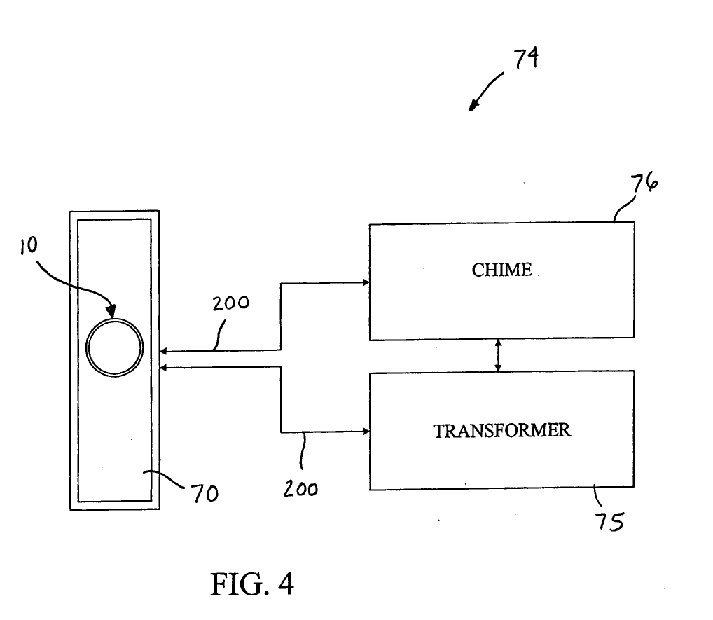

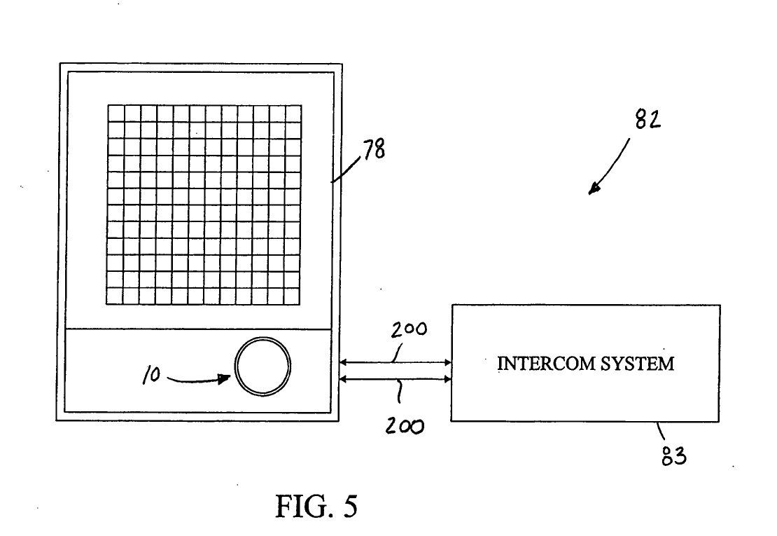

The assembly 10 can be secured in an escutcheon 70 of a door chime signaling device 74 (as shown in FIG. 4), or a speaker box 78 of an intercom signaling device 82 (as shown in FIG. 5). The escutcheon 70 and/or the speaker box 78 can be constructed of plastic, metal, or any other suitable material. As shown in FIG. 4, the door chime signaling device 74 can also include a transformer 75 and a chime 76. As shown in FIG. 5, the intercom signaling device 82 can also include an intercom system 83.

Alternatively, the assembly 10 can be secured directly in an aperture of a wall, molding, or other structure. The housing 14 can be sized for mounting in an opening, bore, cavity, or other aperture, and can have one or more bosses, flanges, fingers, or other elements or features for retaining the housing 14 in the opening. For example, as shown in FIGS. 1-3, the housing 14 can include one or more circumferentially spaced ribs 86 protruding from the exterior of the housing 14 for engagement with walls in an opening.

As shown in FIG. 2, the button assembly 18 can be mounted for movement relative to the housing 14 between a released position and an actuated or depressed position. The button assembly 18 can include a pushbutton 90, a contact mechanism 94, and a spring 98. The pushbutton 90 and the contact mechanism 94 are also shown schematically in FIGS. 6-9. In some embodiments, the pushbutton 90 can be dimensioned to enclose the first end of the base 30. In some embodiments, at least a portion of the pushbutton 90 is constructed of a translucent material (e.g., a translucent plastic or glass material). The pushbutton 90 can be generally cup-shaped and can include a translucent head 102 with a generally cylindrical wall 106 extending from the head 102. Similar to the bezel 42, the head 102 can be tapered or curved. In other embodiments, the pushbutton 90 can be generally flat or can take any other suitable shape. Although the pushbutton 90 can be a substantially rigid element, in some embodiments, the pushbutton 90 can include a flexible membrane, in which case a user can actuate the pushbutton 90 deforming the membrane under pressure.

In some embodiments, the contact mechanism 94 can include a ring portion 110 with contact arms 114 terminating in contacts 118. The ring portion 110 can also include one or more tabs 122 or other projections. The tabs 122 can be used to connect the contact mechanism 94 to an inner surface of the pushbutton 90 and/or can be used to limit movement of the spring 98 relative to the remainder of the contact mechanism 94. In some embodiments, the spring 98 can circumferentially surround the contact mechanism 94, as shown in FIGS. 2 and 3. Although a coil spring is shown in FIGS. 2 and 3, other types of springs (e.g., leaf springs, torsion springs, etc.) can be used to bias the contact arms 114 away from the circuit assembly 22.

In other embodiments, the button assembly 18 can be alternatively configured and/or assembled. For example, the contact arms 114 need not necessarily extend through the spring 98 as shown in FIG. 3, and can instead be located outside of the spring 98. As another example, the contacts 118 need not necessarily be defined at the ends of contact arms 114, as shown in FIG. 3, but can instead be defined by pins, flanges, tabs, or other elements connected to the spring 98 and/or the ring portion 110 of the contact mechanism 94. As yet another example, the contact mechanism 94 need not necessarily have a ring portion 110 as shown in FIG. 2, in which case the contacts 118 can be connected directly to the spring 98 or to any other element suitable for securing the contacts 118 with respect to the spring 98.

As shown in FIG. 2, in some embodiments, the base 30 can include a stepped portion 38a sized to at least partially receive the button assembly 18. The stepped portion 38a can include recesses 38b for receiving the contact arms 114 of the button assembly 18. The recesses 38b and/or stepped portion 38a can also include one or more ramped surfaces to ease assembly of the button assembly 18 into the base 30. When assembled, the contacts 118 can engage an underside of the stepped portion 38a in order to help prevent removal of the button assembly 18 from the base 30. In other embodiments, an inwardly-extending lip or flange of the housing 14 can block removal of the head 102 and/or contact mechanism 94. In still other embodiments, one or more portions of the head 102 and/or contact mechanism 94 can be slidably engaged with the housing 14 in order to secure the button assembly 18 within the housing 14.

As shown in FIG. 2, the spring 98 can be positioned between the stepped portion 38a and the tabs 122 extending from the ring portion 110 such that the pushbutton 90 is biased away from the circuit assembly 22. Actuation of the pushbutton 90 can act against the bias force of the spring 98. When a user actuates the pushbutton 90, the contacts 118 release from the underside of the stepped portion 38a and extend downward toward the circuit assembly 22.

As shown in FIGS. 2 and 3, the circuit assembly 22 can include a circuit board 130, one or more contacts 134, and a circuit 138. The circuit board 130 can include electrical traces laminated and screen etched on a printed circuit board. The contacts 134 can extend from the circuit board 130 to positions in which the contacts 134 can meet the contacts 118 of the contact mechanism 94. The contacts 134 can be mounted to the circuit board 130 in any suitable manner (e.g., rivets 142 or other conventional fasteners, heat staking, adhesive or cohesive bonding material, etc.). The contacts 134 are also shown schematically in FIGS. 6-9.

The circuit assembly 22 can be mounted entirely within the base 30, or can instead be located at least partially outside the housing 14. Also, the circuit assembly 22 can be enclosed in the housing 14 by the cover 34, can instead define part or all of the cover 34, or can be secured to and/or define any other wall of the housing 14.

As shown in FIG. 3, the base 30 can include a portion 38c that defines surfaces 38d and 38e for engagement with the circuit assembly 22. In one embodiment, the circuit assembly 22 can be assembled within the base 30 by inserting the circuit assembly 22 into the cavity 38 (as shown in FIG. 3) until the circuit board 130 engages the surface 38d of the portion 38c and the contacts 134 engage the surface 38e of the portion 38c. In some embodiments, the contacts 134 can frictionally engage inner surfaces of the housing 14 to secure the circuit assembly 22.

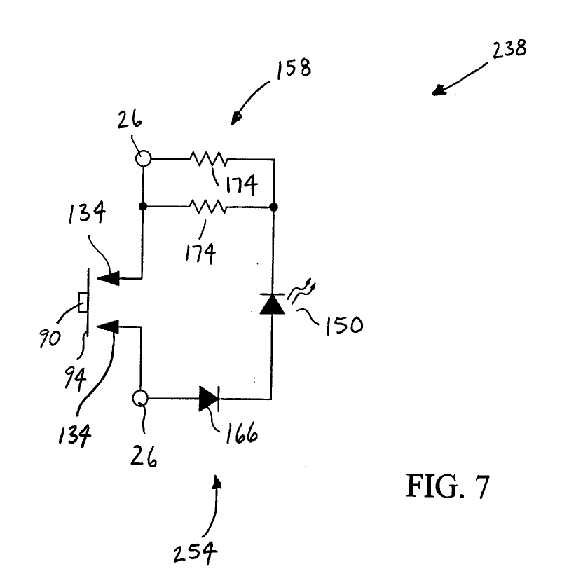

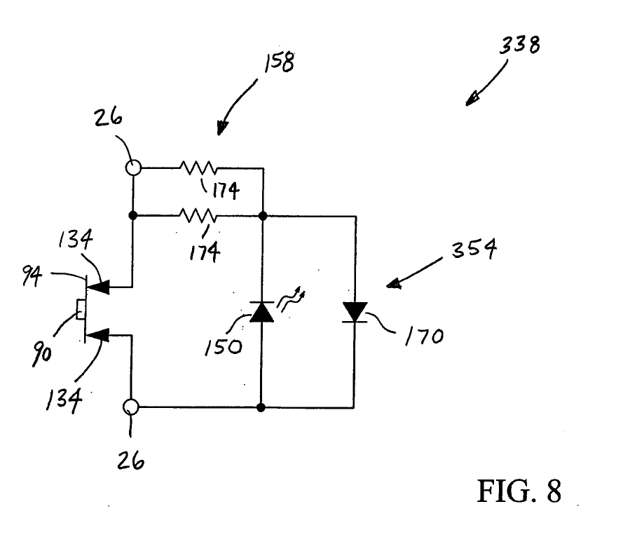

FIG. 6 illustrates a circuit 138 for use in the circuit assembly 22 according to one embodiment of the invention. FIGS. 7 and 8 each illustrate alternative circuits 238 and 338, respectively, that can be used instead of the circuit 138. Like components of the circuits 138, 238, and 338 are illustrated in the figures using like reference numerals. The circuit 138, 238, 338 can include a light-emitting diode (LED) 150, a rectifier circuit 154, 254, 354 (or in some embodiments, a silicon-controlled rectifier), and one or more resistive elements 158. The rectifier circuit 154, 254, 354 can convert an alternating current (AC) supply current to a direct current (DC) drive current.

Each component of the circuit 138, 238, 338 can be mounted on the circuit board 130. In some embodiments, the LED 150 can be mounted on a first side of the circuit board 130 and the rectifier circuit 154, 254, 354 and the resistive elements 158 can be mounted on a second side of the circuit board 130. In other embodiments, the components of the circuit 138, 238, 338 can be alternatively arranged and/or supported.

In some embodiments, one or more resistive elements 158 (see FIGS. 6-9) can be used to limit the DC drive current of the LED 150. Supply voltage greater than the bias voltage of LED 150 must be distributed to the resistive elements 158, so that the DC drive current is below the limits of the LED 150.

The LED 150 can be formed from various doped semiconductor materials in the form of a P-N diode junction. When electrical current passes through the junction in the forward direction, the electrical carriers lose energy proportional to the forward current through the diode junction, which is emitted in the form of visible radiation or light. The amount of light emitted by the LED 150 can be proportional to the amount of current passing through the LED 150 in the forward bias direction. As the current is varied, the output of the light can vary in a similar fashion. In some embodiments, the LED 150 can provide steady-state illumination (e.g., as provided by a standard LED) and/or non-steady-state illumination (e.g., flashing illumination as provided by a flashing LED). In some embodiments, light emitted by the LED 150 can include a range of wavelengths from approximately 380-760 nanometers, although LEDs emitting other ranges of wavelengths can be used in other embodiments. The LED 150 can output any suitable color (e.g., white, violet, indigo, blue, green, yellow, orange, amber, red, etc.) or any suitable color combination (e.g., as provided by multi-color LEDs or multiple separate LEDs).

In some embodiments, the color emitted by the LED 150 can automatically change or can be changed by a user. For example, the color emitted by the LED 150 can automatically change as a function of time, such as by changing every hour, day, etc. As another example, the color emitted by the LED 150 can be changed by user action, such as the LED 150 changing color upon actuation of the pushbutton 90. In some embodiments, the color emitted by the LED 150 can be changed by entering a programming mode of the circuit assembly 22, such as by pressing and holding the pushbutton 90 for a threshold period of time (e.g., five or ten seconds) or by repeatedly pressing the pushbutton 90 in a particular manner or pattern. Once such a programming mode is entered, the color emitted by the LED 150 can be changed by further actuation of the pushbutton 90. For example, the LED color can be changed with each actuation of the pushbutton 90 while in the programming mode or can cycle through colors while the pushbutton 90 is actuated. As discussed further below, the LED 150 can include a control device in addition to the P-N diode junction, such as a programmable device used to provide for such color change.

As shown in FIG. 6, the rectifier circuit 154 can include a full-wave rectifier with four diodes 162 in a bridge arrangement. As shown in FIGS. 7 and 8, the rectifier circuit 254, 354 can include a half-wave rectifier. As shown in FIG. 7, the half-wave rectifier 254 can include a single diode 166 connected in series with the LED 150. As shown in FIG. 8, the half-wave rectifier 354 can include a single diode 170 connected in parallel with the LED 150.

Although half-wave rectifiers typically include fewer components than full-wave rectifiers (i.e., one diode instead of four), half-wave rectifiers only rectify either the positive portion of the AC supply current or the negative portion of the AC supply current. Accordingly, circuits that use half-wave rectifiers to drive the LED 150 can require approximately twice as much current to generate the same amount of illumination. Further, because half-wave rectifiers are polarity sensitive, if the DC power supply is not properly connected to the circuit, the LED 150 will not emit light.

The rectifier circuit 154 can be configured to receive a supply current including an alternating current and/or a direct current. The supply current can be provided to the circuit 138, 238, 338 via wires 200 extending from a power supply (e.g., an AC power supply, such as the transformer 75 of FIG. 4, or a DC power supply, such as one associated with the intercom system 83 of FIG. 5). The power supply can be positioned locally or remotely from the pushbutton switch assembly 10. The wires 200 can be connected to the circuit 138, 238, 338 using the electrical connectors 26. As shown in FIG. 3, the L-shaped surfaces 54 can assist in the connection, retention, and isolation of the wires 200. The electrical connectors 26 can extend through the apertures 50 and be connected to the contacts 134 (e.g., via the rivets 142).

As noted, the electrical connectors 26 and the contacts 134 are also schematically illustrated in FIGS. 6-9. As shown in FIGS. 6-8, the contacts 134 are electrically connected to the remaining components of the circuit 138, 238, 338. As should be understood by one of ordinary skill in the art, the supply current and the associated supply voltage are intended to include the current and the associated voltage generated by one or more AC and/or DC power supplies, or the current and the associate voltage received at the circuit 138, 238, 338 taking into account any current losses or voltage drops.

When the pushbutton 90 is not actuated, the rectifier circuit 154, 254, 354 can receive the supply current and can generate a drive current using the supply current. The drive current can include a direct current, and can be generated using a DC power supply, and/or an AC power supply. With the full-wave rectifier 154 of FIG. 6, the polarity of the DC drive voltage associated with the drive current is independent of the polarity of the DC supply voltage associated with the supply current. In other words, regardless of the polarity of DC supply voltage provided to the circuit 138, the DC drive voltage can include a polarity to properly bias the LED 150. The DC drive voltage associated with the DC drive current can be sufficient to overcome the forward voltage drop of the P-N junction of the LED 150. When the forward voltage drop is overcome (i.e., when the LED 150 is properly biased), the LED 150 turns on and emits light.

Referring to FIGS. 2, 6, 7, and 8, when the pushbutton 90 is actuated in some embodiments, the contacts 118 of the contact mechanism 94 engage the contacts 134 and the circuit 138, 238, 338 is short circuited (i.e., the effective resistance between the contacts 134 can be approximately equal to zero). When the circuit 138, 238, 338 is short-circuited, power is provided to a signaling device (e.g., the door chime signaling device 74 of FIG. 4 or the intercom signaling device 82 of FIG. 5). In this manner, a signal generating device (e.g., the chime 76 of FIG. 4 or the speaker 78 of FIG. 5) generates one or more signals. The signals can include one or more of an auditory signal (e.g., a chime, a bell, or any other suitable sound) and a visual signal (e.g., a flashing light, text shown on a display, or any other suitable graphics).

When a signal is generated using an electromechanical door chime signaling device, removal of the signal can cause an inductive surge. The inductive surge can affect the supply current received by the circuit 138, 238, 338, and potentially, the drive current generated to power the LED 150. In some embodiments, one or more diodes connected in parallel with the LED 150 (e.g., diodes 162 of FIG. 6 and a diode 170 of FIG. 8) can be used to route a portion of the drive current around the LED 150, thus limiting the flow of current through the LED 150. Also in some embodiments, the diode(s) 162, 170 can route current around the LED 150 because the forward voltage drop of the diode(s) 162, 170 is less than the peak inverse voltage (PIV) of the LED 150. The diode(s) 162, 170 can protect the LED 150 from electrical power transients, such as an inductive surge of current that might otherwise be harmful to the LED 150.

In some embodiments, one or more resistive elements 158 can be used in combination with the diode(s) 162, 170 (e.g., see FIGS. 6 and 8) or independently (e.g., see FIG. 7) to absorb inductive surges that may arise when the pushbutton 90 is released. Door chime signaling devices are often electromechanical and often include a coil of wire that is highly inductive. When the pushbutton 90 is released, the coil of wire may cause a larger than nominal voltage build up until the inductive field collapses, which causes a current surge. The inductive surge could damage components, including the LED 150, that do not have the capacity to withstand the inductive surge. The resistive element 158 can take a number of different forms, and in some embodiments as shown in FIGS. 6-9, includes two biasing resistors 174 connected in parallel. Use of the two resistors 174 connected in parallel can provide enhanced surge protection when compared with a single resistor having a wattage equivalent to the combined resistors 174. However, in some embodiments, the resistive element 158 can include a single resistor.

The signaling device 74, 82 can generate one or more signals when the pushbutton 90 is actuated. The signaling device 74, 82 is generally intended to generate a first signal to alert residents of the presence of a visitor. However, the visitor may be unsure whether the pushbutton 90 was fully and properly actuated. Accordingly, in some embodiments, a second signal can be generated at the switch assembly 10 to indicate to the visitor that the pushbutton 90 has been properly actuated. Further, although actuation of the pushbutton 90 generally results in the generation of a first signal to the residents, in some instances (e.g., broken components of the switch assembly 10 and/or broken components of the signaling device 74, 82), the first signal to the residents may not be generated. Accordingly, in some embodiments, a second signal can be generated at the switch assembly 10 to indicate to the visitor that the signaling device 74, 82 did generate the first signal to the residents. The second signal generated at the switch assembly 10 can include an auditory signal and/or a visual signal. It should be understood by one of ordinary skill in the art that the term “resident” can include any occupant inside of a building or inside of a particular portion of a building and the term “visitor” can include any person seeking entry to the building or to a particular portion of the building or wanting to communicate with any occupant inside of the building.

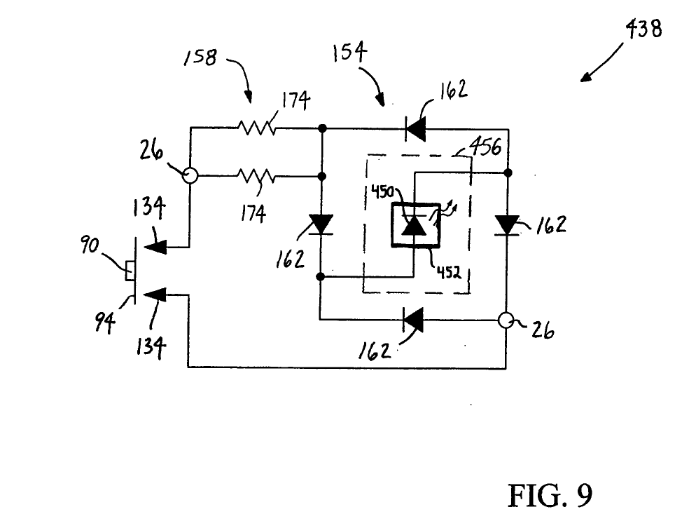

FIG. 9 illustrates a circuit 438 according to another embodiment of the invention. Like components of the circuits 138 and 438 are illustrated in the figures using like reference numerals. The circuit 438 can include an LED assembly 456. In some embodiments, the LED assembly 456 can include an LED 450 having a control device in addition to a P-N junction. In some embodiments, the LED assembly 456 can include a programmable device 452 associated with the LED 450. Whether the control device is embedded in the LED 450 or separately associated with the LED 450, the LED assembly 456 can be configured to detect a sequence of applied power (e.g., the duration and/or frequency of applied power) or to detect other external signals. For example, the LED assembly 456 can be configured to detect signals provided by switches used to program the LED assembly 456. As another example, the LED assembly 456 can be configured to detect a signal within a range of frequencies in order to determine whether the signaling device 74 or 82 generated a first signal to the resident. Such detection can be used to control the second signal generated for the visitor at the switch assembly 10 and/or to control the illumination provided by the LED assembly 456.

In some embodiments, the LED assembly 456 can detect the power interruption when the pushbutton 90 is actuated and the circuit 438 is short-circuited. The LED assembly 456 can detect when the pushbutton 90 is released by detecting power being provided to the circuit 438 again. Once power is provided to the circuit 438 again, the switch assembly 10 can generate a second signal for the visitor to indicate that the first signal was provided to the residents. The second signal provided for the visitor at the switch assembly 10 can include a change in color or timing of the LED 450, such as any one of the following: a change of the LED 450 from steady-state illumination to non-steady-state illumination; a change from non-steady-state illumination to steady-state illumination; a change in the color and/or intensity of illumination of the LED 450; or a sound generated by a sounding device (e.g., a piezoelectric device) connected to the LED assembly 456.

In some embodiments, the LED assembly 456 can control the light emitted by the LED 450 based on various types of information stored in the programmable device 452. For example, the color emitting by the LED 450 can change as a function of time. As other examples, the color emitting by the LED 450 can change on holidays, the colors and/or intensities emitted by the LED 450 can change based upon the time of day, or the light emitted by the LED 450 can change between a constant or blinking mode (e.g., steady-state or non-steady-state illumination). As yet another example, light emitted by the LED 450 can change when the pushbutton 90 moves between the released and actuated positions, such as by brightening or dimming the LED 450 for a period of time, by changing the color emitted by the LED 450, or by changing between blinking and constant modes. As still another example, the LED assembly 456 can have a programming mode to allow a user to change the settings of the LED 450.

The pushbutton switch assembly 10 can be used to replace existing pushbutton switch assemblies and/or as a component of a new signaling device being installed. When used to replace an existing pushbutton switch assembly (e.g., a pushbutton switch assembly including an incandescent bulb), the existing pushbutton switch assembly can be disconnected from the power supply by disconnecting the wires 200, and the pushbutton switch assembly 10 can be connected to the wires 200. In some embodiments, no additional wiring or replacement of components is necessary to replace an existing pushbutton switch assembly, regardless of the design of the existing pushbutton switch assembly (e.g., regardless of an AC or DC power supply being connected to the existing pushbutton switch assembly). An existing pushbutton switch assembly can be replaced with the pushbutton switch assembly 10 for a number of reasons, such as to replace a broken pushbutton switch assembly, to illuminate the button with a colored light, to reduce power consumption, and/or to increase pushbutton reliability.

Many conventional pushbutton switch assemblies are a hard-wired component of a signaling device connected to an AC power supply. However, alternating current is not acceptable for the operation of most LEDs. Accordingly, the pushbutton switch assembly 10 includes a rectifier circuit 154, 254, 354 to convert the AC supply current to a DC drive current.

Some conventional pushbutton switch assemblies are powered with a DC power supply, such as one or more batteries. However, the polarity of the associated DC supply voltage (often provided to an existing pushbutton switch assembly via wires within walls) is not always readily apparent to an installer of a new pushbutton assembly. LEDs commonly do not operate and may be damaged when improperly connected to receive DC power. Accordingly, when installing the pushbutton switch assembly 10 in a signaling device that is connected to a DC power supply (e.g., the intercom signaling device 82 shown in FIG. 5), the wires 200 can be connected to the electrical conductors 26 without regard to the polarity of the DC power supply, if the pushbutton switch assembly 10 includes the circuit 138 of FIG. 6 or another circuit that is not polarity sensitive. In general, the circuit 138 of FIG. 6 can be bi-directional so that regardless of the polarity a voltage provided by a DC power supply, the pushbutton switch assembly 10 can be installed by simply connecting the electrical connectors 26 to the wires 200.

The embodiments described above and illustrated in the figures are presented by way of example only and are not intended as a limitation upon the concepts and principles of the invention. As such, it will be appreciated by one having ordinary skill in the art that various changes in the elements and their configuration and arrangement are possible without departing from the spirit and scope of the invention as set forth in the appended claims.

1. A pushbutton switch assembly, an AC supply current being provided to the pushbutton switch assembly, the pushbutton switch assembly comprising:
a pushbutton;
a light-emitting diode that illuminates the pushbutton; and
a rectifier circuit connected to the light-emitting diode, the rectifier circuit converting the AC supply current to a DC drive current and providing the DC drive current to the light-emitting diode.

2. The pushbutton switch assembly of claim 1 wherein the rectifier circuit includes at least one diode.

3. The pushbutton switch assembly of claim 1 wherein the rectifier circuit includes a full-wave rectifier.

4. The pushbutton switch assembly of claim 3 wherein the full-wave rectifier includes at least one diode connected in parallel with the light-emitting diode.

5. The pushbutton switch assembly of claim 3 wherein the full-wave rectifier includes four diodes connected in a bridge arrangement.

6. The pushbutton switch assembly of claim 1 wherein the rectifier circuit includes a half-wave rectifier.

7. The pushbutton switch assembly of claim 6 wherein the half-wave rectifier includes a diode connected in series with the light-emitting diode.

8. The pushbutton switch assembly of claim 6 wherein the half-wave rectifier includes a diode connected in parallel with the light-emitting diode.

9. The pushbutton switch assembly of claim 1 wherein the pushbutton causes a signaling device to generate a signal when the pushbutton is actuated, and the signal including at least one of an auditory signal and a visual signal.

10. The pushbutton switch assembly of claim 9 wherein the signaling device includes an intercom.

11. The pushbutton switch assembly of claim 9 wherein the signaling device includes a door chime.

12. The pushbutton switch assembly of claim 1 wherein the rectifier circuit includes at least one resistive element to limit a light-emitting diode drive current.

13. The pushbutton switch assembly of claim 1 wherein the rectifier circuit includes at least one resistive element that protects the light-emitting diode from excessive current flowing through the lighting-emitting diode due to an inductive surge.

14. The pushbutton switch assembly of claim 1 wherein:
the rectifier circuit is short circuited when the pushbutton is actuated; and
the light-emitting diode does not illuminate the pushbutton when the pushbutton is actuated.

15. The pushbutton switch assembly of claim 1 wherein at least a portion of the pushbutton is substantially translucent.

16. The pushbutton switch assembly of claim 1 wherein the light-emitting diode causes the pushbutton to appear at least one of orange, amber, yellow, red, green, blue, violet, and indigo.

17. The pushbutton switch assembly of claim 1 and further comprising a circuit board, the light-emitting diode and the rectifier circuit being mounted to the circuit board.

18. The pushbutton switch assembly of claim 17 and further comprising at least one diode mounted on a side of the circuit board opposite the light-emitting diode.

19. The pushbutton switch assembly of claim 1 wherein:
a signal is generated for a visitor when the visitor actuates the pushbutton; and
the signal includes at least one of an auditory signal and a visual signal.

20. The pushbutton switch assembly of claim 19 and further comprising a piezoelectric device that generates the auditory signal.

21. The pushbutton switch assembly of claim 19 wherein the visual signal includes a change between a first color and a second color being emitted by the light-emitting diode.

22. The pushbutton switch assembly of claim 21 wherein the light-emitting diode includes a multi-color light-emitting diode.

23. The pushbutton switch assembly of claim 19 wherein:
the visual signal generated after the pushbutton is actuated includes at least one of a steady-state illumination and a non-steady-state illumination; and
the light-emitting diode generates an opposite one of the steady-state illumination and the non-steady-state illumination before the pushbutton is actuated.

24. The pushbutton switch assembly of claim 1 wherein a color emitted by the light-emitting diode changes after the pushbutton is actuated.

25. The pushbutton switch assembly of claim 1 wherein a color emitted by the light-emitting diode is selected from a plurality of colors.

26. The pushbutton switch assembly of claim 1 and further comprising a programmable device connected to the light-emitting diode, the programmable device controlling at least one of color and timing of the light-emitting diode.

27. A pushbutton switch assembly, a DC supply current being provided to the pushbutton switch assembly, the pushbutton switch assembly comprising:
a pushbutton;
a light-emitting diode that illuminates the pushbutton; and
a rectifier circuit connected to the light-emitting diode, the rectifier circuit providing a DC drive current to the light-emitting diode from the DC supply current regardless of a polarity of a voltage associated with the DC supply current.

28. The pushbutton switch assembly of claim 27 wherein the rectifier circuit includes at least one diode.

29. The pushbutton switch assembly of claim 27 wherein the rectifier circuit includes a full-wave rectifier.

30. The pushbutton switch assembly of claim 29 wherein the full-wave rectifier includes at least one diode connected in parallel with the light-emitting diode.

31. The pushbutton switch assembly of claim 29 wherein the full-wave rectifier includes four diodes connected in a bridge arrangement.

32. The pushbutton switch assembly of claim 27 wherein the rectifier circuit includes a half-wave rectifier.

33. The pushbutton switch assembly of claim 32 wherein the half-wave rectifier includes a diode connected in series with the light-emitting diode.

34. The pushbutton switch assembly of claim 32 wherein the half-wave rectifier includes a diode connected in parallel with the light-emitting diode.

35. The pushbutton switch assembly of claim 27 wherein the pushbutton causes a signaling device to generate a signal when the pushbutton is actuated, and the signal including at least one of an auditory signal and a visual signal.

36. The pushbutton switch assembly of claim 35 wherein the signaling device includes an intercom.

37. The pushbutton switch assembly of claim 35 wherein the signaling device includes a door chime.

38. The pushbutton switch assembly of claim 27 wherein the rectifier circuit includes at least one resistive element to limit a light-emitting diode drive current.

39. The pushbutton switch assembly of claim 27, wherein the rectifier circuit includes at least one resistive element that protects the light-emitting diode from excessive current flowing through the lighting-emitting diode due to an inductive surge.

40. The pushbutton switch assembly of claim 27 wherein:
the rectifier circuit is short circuited when the pushbutton is actuated; and
the light-emitting diode does not illuminate the pushbutton when the pushbutton is actuated.

41. The pushbutton switch assembly of claim 27 wherein at least a portion of the pushbutton is substantially translucent.

42. The pushbutton switch assembly of claim 27 wherein the light-emitting diode causes the pushbutton to appear at least one of orange, amber, yellow, red, green, blue, violet, and indigo.

43. The pushbutton switch assembly of claim 27 and further comprising a circuit board, the light-emitting diode and the rectifier circuit being mounted to the circuit board.

44. The pushbutton switch assembly of claim 43 and further comprising at least one diode mounted on a side of the circuit board opposite the light-emitting diode.

45. The pushbutton switch assembly of claim 27 wherein:
a signal is generated for a visitor when the visitor actuates the pushbutton; and
the signal includes at least one of an auditory signal and a visual signal.

46. The pushbutton switch assembly of claim 45 and further comprising a piezoelectric device that generates the auditory signal.

47. The pushbutton switch assembly of claim 45 wherein the visual signal includes a change between a first color and a second color being emitted by the light-emitting diode.

48. The pushbutton switch assembly of claim 47 wherein the light-emitting diode includes a multi-color light-emitting diode.

49. The pushbutton switch assembly of claim 47 wherein:
the visual signal generated after the pushbutton is actuated includes at least one of a steady-state illumination and a non-steady-state illumination; and
the light-emitting diode generates an opposite one of the steady-state illumination and the non-steady-state illumination before the pushbutton is actuated.

50. The pushbutton switch assembly of claim 27 wherein a color emitted by the light-emitting diode changes after the pushbutton is actuated.

51. The pushbutton switch assembly of claim 27 wherein a color emitted by the light-emitting diode is selected from a plurality of colors.

52. The pushbutton switch assembly of claim 27 and further comprising a programmable device connected to the light-emitting diode, the programmable device controlling at least one of color and timing of the light-emitting diode.

53. A pushbutton switch assembly, one of an AC supply current and a DC supply current being provided to the pushbutton switch assembly, the pushbutton switch assembly comprising:
a pushbutton;
a light-emitting diode that illuminates the pushbutton; and
a rectifier circuit connected to the light-emitting diode,
if the AC supply current is provided, the rectifier circuit converting the AC supply current to a DC drive current, the rectifier circuit providing the DC drive current to the light-emitting diode,
if the DC supply current is provided, the rectifier circuit providing a DC drive current to the light-emitting diode from the DC supply current regardless of a polarity of a voltage associated with the DC supply current.

54. The pushbutton switch assembly of claim 53 wherein the rectifier circuit includes at least one diode.

55. The pushbutton switch assembly of claim 53 wherein the rectifier circuit includes a full-wave rectifier.

56. The pushbutton switch assembly of claim 55 wherein the full-wave rectifier includes at least one diode connected in parallel with the light-emitting diode.

57. The pushbutton switch assembly of claim 55 wherein the full-wave rectifier includes four diodes connected in a bridge arrangement.

58. The pushbutton switch assembly of claim 53 wherein the rectifier circuit includes a half-wave rectifier.

59. The pushbutton switch assembly of claim 58 wherein the half-wave rectifier includes a diode connected in series with the light-emitting diode.

60. The pushbutton switch assembly of claim 58 wherein the half-wave rectifier includes a diode connected in parallel with the light-emitting diode.

61. The pushbutton switch assembly of claim 53 wherein the pushbutton causes a signaling device to generate a signal when the pushbutton is actuated, and the signal includes at least one of an auditory signal and a visual signal.

62. The pushbutton switch assembly of claim 53 wherein the rectifier circuit includes at least one resistive element to limit a light-emitting diode drive current.

63. The pushbutton switch assembly of claim 53 wherein the rectifier circuit includes at least one resistive element that protects the light-emitting diode from excessive current flowing through the lighting-emitting diode due to an inductive surge.

64. An assembly for use by a visitor and a resident of a building, the assembly comprising:
a pushbutton;
a light-emitting diode that illuminates the pushbutton;
a programmable device connected to the light-emitting diode; and
a signaling device connected to the programmable device, the signaling device generating a first signal and a second signal when the visitor actuates the pushbutton,
the first signal notifying the resident that the visitor is present, the first signal including at least one of a first auditory signal and a first visual signal,
the second signal indicating to the visitor that the resident has been notified, the second signal including at least one of a second auditory signal and a second visual signal, the second visual signal including a change in at least one of color and timing of the light-emitting diode.

65. The assembly of claim 64 wherein the signaling device includes at least one of a door chime and an intercom.

66. The assembly of claim 64 wherein:
the rectifier circuit is short circuited when the pushbutton is actuated; and
the light-emitting diode does not illuminate the pushbutton when the pushbutton is actuated.

67. The assembly of claim 64 wherein at least a portion of the pushbutton is substantially translucent.

68. The assembly of claim 64 wherein the light-emitting diode causes the pushbutton to appear at least one of orange, amber, yellow, red, green, blue, violet, and indigo.

69. The assembly of claim 64 wherein the signaling device includes a piezoelectric device that generates the second auditory signal.

70. The assembly of claim 64 wherein the second visual signal includes a change between a first color and a second color being emitted by the light-emitting diode.

71. The assembly of claim 70 wherein the light-emitting diode includes a multi-color light-emitting diode.

72. The assembly of claim 64 wherein:
the second visual signal includes at least one of a steady-state illumination and a non-steady-state illumination; and
the light-emitting diode generates an opposite one of the steady-state illumination and the non-steady-state illumination before the pushbutton is actuated.

73. The assembly of claim 64 wherein the second visual signal includes a color emitted by the light-emitting diode changing after the pushbutton is actuated.

74. The assembly of claim 64 wherein a color emitted by the light-emitting diode is selected from a plurality of colors and stored in the programmable device.

75. A replacement pushbutton assembly for replacing an existing pushbutton assembly, the replacement pushbutton assembly comprising:
a housing;
a pushbutton coupled to the housing;
a circuit board positioned within the housing;
a light-emitting diode coupled to the circuit board, the light-emitting diode illuminating the pushbutton; and
a rectifier circuit coupled to the circuit board and electrically connected to the light-emitting diode, the rectifier circuit providing a DC drive current to the light-emitting diode regardless of whether power is provided to the existing pushbutton assembly from an AC power source or a DC power source and regardless of a polarity of a voltage associated with the DC power source.
